(19) United States
(12) Patent Application Publication
(10) Pub. No.: US 2024/0336708 A1
(43) Pub. Date: Oct. 10, 2024

(54) PURIFIED GUAYULE NATURAL RUBBER AND RELATED PROCESSES

(71) Applicant: Bridgestone Corporation, Chuo-ku (JP)

(72) Inventors: Michael Richard Hartzell, Gold Canyon, AZ (US); Robert Ward White, Gilbert, AZ (US); Taigyoo Park, Mesa, AZ (US); Mark DeDecker, North Canton, OH (US); Yingyi Huang, Hudson, OH (US)

(73) Assignee: Bridgestone Corporation, Chuo-ku, TK (JP)

(21) Appl. No.: 18/698,721

(22) PCT Filed: Oct. 6, 2022
(86) PCT No.: PCT/US2022/077693

§ 371 Date: Apr. 4, 2024

Related U.S. Application Data
(60) Provisional application No. 63/252,678, filed on Oct. 6, 2021.

(51) Int. Cl. C08C 3/02; C08C 1/04

(52) U.S. Cl. CPC C08C 3/02; C08C 1/04

(57) ABSTRACT

A purified guayule natural rubber is provided which has a particular Mw, Mn, Mw/Mn, resin content and ash content. Also provided are related processes for obtaining the purified guayule natural rubber from an initial co-solvent based miscella which contains solubilized guayule rubber, at least one polar solvent and at least one non-polar solvent using a fractionation system.

### FIELD

The present application is directed to a purified guayule natural rubber and related processes for preparing a purified guayule natural rubber.

### BACKGROUND

Guayule natural rubber is a natural rubber that is sourced from the guayule plant (Parthenium argentatum), a woody shrub-like plant that produces both rubber and resin within its cells.

### SUMMARY

Disclosed herein is a purified guayule natural rubber having particular properties in terms of weight average molecular weight, number average molecular weight, and polydispersity as well as specified amounts of resin and ash content. Also disclosed are related processes for providing or preparing the purified guayule natural rubber.

In a first embodiment, a purified guayule natural rubber is provided which has (a) a Mw of at least 1.2 million grams/mole, preferably 1.25 to 1.35 grams/mole, (b) an Mn of at least 0.25 million grams/mole, preferably 0.3 to 0.4 million grams/mole, (c) a Mw/Mn of 3-4, preferably 3.3 to 3.8, (d) a resin content of about 0.5 to about 5% by weight, and (e) an ash content of about 0.1 to about 0.2 weight %.

In a second embodiment, a process for preparing a purified guayule natural rubber is provided. The process of second embodiment comprises (a) providing an initial co-solvent based miscella comprising at least one polar solvent in an amount about 55 to about 70% by weight based upon the total weight of solvents in the initial co-solvent based miscella, at least one non-polar solvent, solubilized guayule rubber, and solubilized resin; (b) using a fractionation system comprising multiple fractionators connected in series to separate the initial co-solvent based miscella into at least two phases, wherein the multiple fractionators include a first fractionator, at least two intermediate fractionators including a first intermediate fractionator and a second intermediate fractionator, and a final fractionator, and wherein each fractionator comprises a primary vessel; wherein the initial co-solvent based miscella is fed into the first fractionator primary vessel, and the initial co-solvent based miscella separates to form (i) a first non-polar solvent viscous rubber phase in a lower portion of the first fractionator primary vessel and (ii) a first polar solvent solubilized resin phase above the first non-polar solvent viscous rubber phase; (c) allowing the first polar solvent solubilized resin phase to flow out of the first fractionator; (d) allowing the first non-polar solvent viscous rubber phase to flow out of the first fractionator primary vessel; (e) adding a combination of a first washing solution comprising a combination of polar solvent and non-polar solvent and the first non-polar solvent viscous rubber phase to the first intermediate fractionator primary vessel to form a first co-solvent based miscella mixture and allowing for separation of the first co-solvent based miscella mixture into (i) a first intermediate non-polar solvent viscous rubber phase in a lower portion of the first intermediate fractionator primary vessel and (ii) a first intermediate polar solvent solubilized resin phase above the first intermediate non-polar solvent viscous rubber phase, wherein the first washing solution comprises about 40 to about 80% by weight of polar solvent based upon the total weight of solvents in the first washing solution, and the first washing solution is added in an amount sufficient to provide a weight ratio of first washing solution to non-polar solvent viscous rubber phase from the first fractionator primary vessel of 0.5:1 to 5:1; (f) allowing the first intermediate polar solvent solubilized resin phase to flow out of the first intermediate fractionator primary vessel; (g) allowing the first intermediate non-polar solvent viscous rubber phase to flow out of the first intermediate fractionator primary vessel; (h) adding a combination of a second washing solution comprising polar solvent and non-polar solvent and the first intermediate non-polar solvent viscous rubber phase to the second intermediate fractionator primary vessel to form a second co-solvent based miscella mixture and allowing for separation of the second co-solvent based miscella mixture into (i) a second intermediate non-polar solvent viscous rubber phase in a lower portion of the second intermediate fractionator primary vessel and (ii) a second intermediate polar solvent solubilized resin phase above the second intermediate non-polar solvent viscous rubber phase, wherein the second washing solution comprises about 40 to about 80% by weight of polar solvent based upon the total weight of solvents in the second washing solution, and the second washing solution is added in an amount sufficient to provide a weight ratio of second washing solution to non-polar solvent viscous rubber phase from the second fractionator primary vessel of 0.5:1 to 5:1; (i) allowing the second intermediate polar solvent solubilized resin phase to flow out of the second intermediate fractionator primary vessel; (j) allowing the second intermediate non-polar solvent viscous rubber phase to flow out of the second intermediate fractionator primary vessel; (k) adding a combination of a third washing solution comprising polar solvent and non-polar solvent and the second intermediate non-polar solvent viscous rubber phase to the final fractionator primary vessel to form a final co-solvent based miscella mixture and allowing for separation of the final co-solvent based miscella mixture into (i) a final non-polar solvent viscous rubber phase in a lower portion of the final fractionator primary vessel and (ii) a final polar solvent solubilized resin phase above the final non-polar solvent viscous rubber phase, wherein the third washing solution comprises about 40 to about 80% by weight of polar solvent based upon the total weight of solvents in the third washing solution, and the third washing solution is added in an amount sufficient to provide a weight ratio of third washing solution to non-polar solvent viscous rubber phase from the third fractionator primary vessel of 0.5:1 to 5:1; (l) allowing the final polar solvent solubilized resin phase to flow out of the final fractionator primary vessel; (m) allowing the final non-polar solvent viscous rubber phase to flow out of the final fractionator primary vessel, thereby providing a separated solubilized rubber phase with reduced resin and polar solvent content as compared to the initial co-solvent based miscella and wherein the separated solubilized rubber phase contains about 75 to about 85% by weight solvents based upon the total weight of the separated solubilized rubber phase; and (n) removing solvent from the separated solubilized rubber phase to produce a purified guayule rubber having a solvent content of no more than 0.5% by weight.

### DETAILED DESCRIPTION

Disclosed herein is a purified guayule natural rubber having particular properties in terms of weight average molecular weight, number average molecular weight, and polydispersity as well as specified amounts of resin and ash content. Also disclosed are related processes for providing or preparing the purified guayule natural rubber.

In a first embodiment, a purified guayule natural rubber is provided which has (a) a Mw of at least 1.2 million grams/mole, preferably 1.25 to 1.35 grams/mole, (b) an Mn of at least 0.25 million grams/mole, preferably 0.3 to 0.4 million grams/mole, (c) a Mw/Mn of 3-4, preferably 3.3 to 3.8, (d) a resin content of about 0.5 to about 5% by weight, and (e) an ash content of about 0.1 to about 0.2 weight %.

In a second embodiment, a process for preparing a purified guayule natural rubber is provided. The process of second embodiment comprises (a) providing an initial co-solvent based miscella comprising at least one polar solvent in an amount about 55 to about 70% by weight based upon the total weight of solvents in the initial co-solvent based miscella, at least one non-polar solvent, solubilized guayule rubber, and solubilized resin; (b) using a fractionation system comprising multiple fractionators connected in series to separate the initial co-solvent based miscella into at least two phases, wherein the multiple fractionators include a first fractionator, at least two intermediate fractionators including a first intermediate fractionator and a second intermediate fractionator, and a final fractionator, and wherein each fractionator comprises a primary vessel; wherein the initial co-solvent based miscella is fed into the first fractionator primary vessel, and the initial co-solvent based miscella separates to form (i) a first non-polar solvent viscous rubber phase in a lower portion of the first fractionator primary vessel and (ii) a first polar solvent solubilized resin phase above the first non-polar solvent viscous rubber phase; (c) allowing the first polar solvent solubilized resin phase to flow out of the first fractionator; (d) allowing the first non-polar solvent viscous rubber phase to flow out of the first fractionator primary vessel; (e) adding a combination of a first washing solution comprising a combination of polar solvent and non-polar solvent and the first non-polar solvent viscous rubber phase to the first intermediate fractionator primary vessel to form a first co-solvent based miscella mixture and allowing for separation of the first co-solvent based miscella mixture into (i) a first intermediate non-polar solvent viscous rubber phase in a lower portion of the first intermediate fractionator primary vessel and (ii) a first intermediate polar solvent solubilized resin phase above the first intermediate non-polar solvent viscous rubber phase, wherein the first washing solution comprises about 40 to about 80% by weight of polar solvent based upon the total weight of solvents in the first washing solution, and the first washing solution is added in an amount sufficient to provide a weight ratio of first washing solution to non-polar solvent viscous rubber phase from the first fractionator primary vessel of 0.5:1 to 5:1; (f) allowing the first intermediate polar solvent solubilized resin phase to flow out of the first intermediate fractionator primary vessel; (g) allowing the first intermediate non-polar solvent viscous rubber phase to flow out of the first intermediate fractionator primary vessel; (h) adding a combination of a second washing solution comprising polar solvent and non-polar solvent and the first intermediate non-polar solvent viscous rubber phase to the second intermediate fractionator primary vessel to form a second co-solvent based miscella mixture and allowing for separation of the second co-solvent based miscella mixture into (i) a second intermediate non-polar solvent viscous rubber phase in a lower portion of the second intermediate fractionator primary vessel and (ii) a second intermediate polar solvent solubilized resin phase above the second intermediate non-polar solvent viscous rubber phase, wherein the second washing solution comprises about 40 to about 80% by weight of polar solvent based upon the total weight of solvents in the second washing solution, and the second washing solution is added in an amount sufficient to provide a weight ratio of second washing solution to non-polar solvent viscous rubber phase from the second fractionator primary vessel of 0.5:1 to 5:1; (i) allowing the second intermediate polar solvent solubilized resin phase to flow out of the second intermediate fractionator primary vessel; (j) allowing the second intermediate non-polar solvent viscous rubber phase to flow out of the second intermediate fractionator primary vessel; (k) adding a combination of a third washing solution comprising polar solvent and non-polar solvent and the second intermediate non-polar solvent viscous rubber phase to the final fractionator primary vessel to form a final co-solvent based miscella mixture and allowing for separation of the final co-solvent based miscella mixture into (i) a final non-polar solvent viscous rubber phase in a lower portion of the final fractionator primary vessel and (ii) a final polar solvent solubilized resin phase above the final non-polar solvent viscous rubber phase, wherein the third washing solution comprises about 40 to about 80% by weight of polar solvent based upon the total weight of solvents in the third washing solution, and the third washing solution is added in an amount sufficient to provide a weight ratio of third washing solution to non-polar solvent viscous rubber phase from the third fractionator primary vessel of 0.5:1 to 5:1; (l) allowing the final polar solvent solubilized resin phase to flow out of the final fractionator primary vessel; (m) allowing the final non-polar solvent viscous rubber phase to flow out of the final fractionator primary vessel, thereby providing a separated solubilized rubber phase with reduced resin and polar solvent content as compared to the initial co-solvent based miscella and wherein the separated solubilized rubber phase contains about 75 to about 85% by weight solvents based upon the total weight of the separated solubilized rubber phase; and (n) removing solvent from the separated solubilized rubber phase to produce a purified guayule rubber having a solvent content of no more than 0.5% by weight.

### Definitions

The terminology as set forth herein is for description of the embodiments only and should not be construed as limiting the invention as a whole.

Unless otherwise indicated herein, the term “Mooney viscosity” refers to the Mooney viscosity, ML₁₊₄. As those of skill in the art will understand, a rubber composition's Mooney viscosity is measured prior to vulcanization or curing.

As used herein, the abbreviation Mn is used for number average molecular weight.

As used herein, the abbreviation Mw is used for weight average molecular weight.

As used herein, the abbreviation Mw/Mn refers to polydispersity, which is calculated as the weight average molecular weight of a rubber divided by the number average molecular weight of the rubber.

As used herein, weight percentages of rubber and resin should be understood to refer to the “dry” amount of rubber or resin, such as can be measured by removing solvents from a solvent-containing phase so that no more than 0.5% by weight of solvent remains in the dried sample. As a non-limiting example, if a 100-gram sample of viscous rubber phase were dried to a solvent-content of no more than 0.5% by weight solvent and the remaining rubber was 2.5 grams, then the weight percentage of rubber in the viscous rubber phase would be referred to herein as 2.5% by weight based upon the total weight of the viscous rubber phase.

As used herein, the weight percentages of solvent (e.g., non-polar solvent(s) and polar solvent(s)) should be understood to refer to the percentage of given solvent or type of solvent based upon the total amount of that solvent in a particular phase unless explicitly stated differently. As a non-limiting example, if a 200-gram sample of viscous rubber phase were described as containing 2.5% by weight rubber, 40% by weight polar solvent, and 60% by weight non-polar solvent, then the sample would contain 5 grams rubber, and 195 grams of total solvent of which 78 grams would be polar solvent (i.e., 40% by weight of the total solvent) and 117 grams would be non-polar solvent (i.e., 60% by weight of the total solvent).

### Purified Guayule Natural Rubber

As discussed above, the first embodiment disclosed herein is directed to a purified guayule natural rubber. According to the first embodiment, the purified guayule natural rubber has (a) a Mw of at least 1.2 million grams/mole, preferably 1.25 to 1.35 grams/mole, (b) an Mn of at least 0.25 million grams/mole, preferably 0.3 to 0.4 million grams/mole, (c) a Mw/Mn (also referred to as polydispersity) of 3-4, preferably 3.3 to 3.8, (d) a resin content of about 0.5 to about 5% by weight, and (e) an ash content of about 0.1 to about 0.2 weight %. It is specifically contemplated that according to the first embodiment disclosed herein, the Mw, Mn, Mw/Mn, resin content and ash content of the purified guayule rubber may vary within the foregoing listed ranges to a particular value of one or more of (a)-(e) and/or to a narrower range within one of the foregoing listed ranges for (a)-(e). As a non-limiting example, in certain embodiments of the first embodiment, the purified guayule natural rubber has Mw, Mn and Mw/Mn values according to the preferred ranges listed above (or below) in combination with resin and ash contents as listed above (or below) for (d) and (e). In certain particular embodiments of the first embodiment, the purified guayule natural rubber has a Mw of about 1.3 million grams/mole or 1.3 million grams/mole and a Mn of about 0.35 grams/mole or 0.35 grams/mole. In other particular embodiments of the first embodiment, the purified guayule natural rubber has a Mw of about 1.25 million grams/mole or 1.25 million grams/mole and a Mn of about 0.33 grams/mole or 0.33 grams/mole. The Mw and Mn values (and by extension the Mw/Mn values) referred to herein refer to values measured by GPC using a polystyrene standard.

As mentioned above, according to the first embodiment disclosed herein, the purified guayule natural rubber has a Mw of at least 1.2 million grams/mole (e.g., 1.2, 1.22, 1.24, 1.25, 1.26, 1.28, 1.3, 1.32, 1.34, 1.35, 1.36, 1.38 or 1.4 million grams/mole). In preferred embodiments of the first embodiment, the purified guayule natural rubber has a Mw of 1.25 to 1.35 million grams/mole (e.g., 1.25, 1.26, 1.27, 1.28, 1.29, 1.3, 1.31, 1.32, 1.33, 1.34, or 1.35 million grams/mole).

As mentioned above, according to the first embodiment disclosed herein, the purified guayule natural rubber has a Mn of at least 0.25 million grams/mole (e.g., 0.25, 0.26, 0.28, 0.3, 0.32, 0.34, 0.35, 0.36, 0.38, 0.4, 0.42, 0.44, or 0.45 grams/mole). In preferred embodiments of the first embodiment, the purified guayule natural rubber has a Mn of 0.3 to 0.4 million grams/mole (e.g., 0.3, 0.31, 0.32, 0.33, 0.34, 0.35, 0.36, 0.37, 0.38, 0.39 or 0.4 million grams/mole).

As mentioned above, according to the first embodiment disclosed herein, the purified guayule natural rubber has a Mw/Mn of 3-4 (e.g., 3, 3.1, 3.2, 3.3, 3.4, 3.5, 3.6, 3.7, 3.8, 3.9 or 4). In preferred embodiments of the first embodiment, the purified guayule natural rubber has a Mw/Mn of 3.3 to 3.8 (e.g., 3.3, 3.4, 3.5, 3.6, 3.7, or 3.8). In certain embodiments of the first embodiment, the purified guayule natural rubber has a Mw/Mn of about 3.5 or 3.5.

As mentioned above, according to the first embodiment disclosed herein, the purified guayule natural rubber has a resin content of about 0.5 to about 5% by weight or 0.5 to 5% by weight (e.g., 0.5, 1, 1.5, 2, 2.5, 3, 3.5, 4, 4.5, or 5% by weight). In preferred embodiments of the first embodiment, the purified guayule natural rubber has a resin content of about 1 to about 5% by weight or 1 to 5% by weight (e.g., 1, 1.5, 2, 2.5, 3, 3.5, 4, 4.5, or 5% by weight), more preferably a resin content of about 2 to about 5% by weight or 2 to 5% by weight (e.g., 2, 2.2, 2.4, 2.5, 2.6, 2.8, 3, 3.2, 3.4, 3.5, 3.6, 3.8, 4, 4.2, 4.4, 4.5, 4.6, 4.8 or 5% by weight). The resin content of the purified guayule natural rubber can be determined according to the following acetone extraction procedure. A 9-10 gram sample of guayule rubber is soxhlet extracted for 6 hours with co-solvent (31 mL acetone, 170 mL pentane) to solubilize both rubber and resin. Resin is solubilized into the acetone phase. Solubilized rubber (contained within the pentane phase) can be isolated using methanol coagulation, centrifuging and drying. More specifically, 20 mL of the extract from the soxhlet extraction is transferred to a centrifuge tube and 20 mL of methanol is added to coagulate the rubber. The tube and its contents are centrifuged at 1500 rpm for 20 minutes to separate coagulated rubber from solvent. The supernatant within the tube is decanted into a flask and reserved for % resin determination. The tube and its coagulated rubber contents are rinsed with an aliquot of acetone (10 mL) and the acetone is poured out of the tube into the flask containing the decanted supernatant. The remaining coagulated rubber within the tube is then placed into a vacuum oven that is pre heated to 60° C. and dried under vacuum for 30 minutes. After cooling to room temperature, the tube is weighed and the amount of rubber therein is calculated. Resin content (contained within the acetone phase) is determined by utilizing the flask containing the supernatant and decanted acetone. The solvent is evaporated from the flask in a fume hood until near dryness. The remaining contents are then further dried by placing the flask into an oven at 110° C. for 30 minutes. After cooling, the flask is weighed and the amount of resin remaining in the flask is calculated.

As mentioned above, according to the first embodiment disclosed herein, the purified guayule natural rubber has an ash content of about 0.1 to about 0.2% by weight or 0.1 to 0.2% by weight (e.g., 0.1, 0.11, 0.12, 0.13, 0.14, 0.15, 0.16, 0.17, 0.18, 0.19 or 0.2% by weight). The ash content of purified guayule natural rubber can be determined by measuring the inorganic material (i.e., free of carbon) that remains after ashing a rubber sample rubber at 550° C.+25° C.

According to the first embodiment, the Mooney viscosity of the purified guayule natural rubber may vary. In preferred embodiments of the first embodiment, the purified guayule natural rubber has a ML₁₊₄ at 100° C. of at least 65 (e.g., 65, 66, 67, 68, 69, 70, 71, 72, 73, 74, 75, 76, 77, 78, 79, 80, 82, 83, 84, 85, 86, 87, 88, 89, or 90), more preferably at least 70 (e.g., 70, 71, 72, 73, 74, 75, 76, 77, 78, 79, 80, 82, 83, 84, 85, 86, 87, 88, 89, or 90). It should be understood that according to such embodiments, the ML₁₋₄ at 100° C. can also be within a range encompassed by the foregoing values such as 65-90, preferably 70-90.

Although the above properties of the purified guayule natural rubber are discussed above explicitly with respect to the first embodiment disclosed herein, since the process of the second embodiment disclosed herein is capable of producing a purified guayule natural rubber having the same properties as the purified guayule natural rubber of the first embodiment, all of the above-discussed properties of the guayule natural rubber should be understood to apply equally to a purified guayule natural rubber that results from the process of the second embodiment.

### Processes for Preparing Purified Guayule Natural Rubber

As discussed above, the second embodiment disclosed herein is directed to a process for preparing a purified guayule natural rubber which has (a) a Mw of at least 1.2 million grams/mole, preferably 1.25 to 1.35 grams/mole, (b) an Mn of at least 0.25 million grams/mole, preferably 0.3 to 0.4 million grams/mole, (c) a Mw/Mn (also referred to as polydispersity) of 3-4, preferably 3.3 to 3.8, (d) a resin content of about 0.5 to about 5% by weight, and (e) an ash content of about 0.1 to about 0.2 weight %. More specifically, the process of the second embodiment comprises: (a) providing an initial co-solvent based miscella comprising at least one polar solvent, at least one non-polar solvent, solubilized guayule rubber, and solubilized resin; (b) using a fractionation system comprising multiple fractionators connected in series to separate the initial co-solvent based miscella into at least two phases, wherein the multiple fractionators include a first fractionator, at least two intermediate fractionators including a first intermediate fractionator and a second intermediate fractionator, and a final fractionator, and wherein each fractionator comprises a primary vessel; wherein the initial co-solvent based miscella is fed into the first fractionator primary vessel, and the initial co-solvent based miscella separates to form (i) a first non-polar solvent viscous rubber phase in a lower portion of the first fractionator primary vessel and (ii) a first polar solvent solubilized resin phase above the first non-polar solvent viscous rubber phase; (c) allowing the first polar solvent solubilized resin phase to flow out of the first fractionator; (d) allowing the first non-polar solvent viscous rubber phase to flow out of the first fractionator primary vessel; (e) adding a combination of a first washing solution comprising a combination of polar solvent and non-polar solvent and the first non-polar solvent viscous rubber phase to the first intermediate fractionator primary vessel to form a first co-solvent based miscella mixture and allowing for separation of the first co-solvent based miscella mixture into (i) a first intermediate non-polar solvent viscous rubber phase in a lower portion of the first intermediate fractionator primary vessel and (ii) a first intermediate polar solvent solubilized resin phase above the first intermediate non-polar solvent viscous rubber phase, wherein the first washing solution comprises about 40 to about 80% by weight of polar solvent based upon the total weight of the first washing solution, and the first washing solution is added in an amount sufficient to provide a weight ratio of first washing solution to non-polar solvent viscous rubber phase from the first fractionator primary vessel of 0.5:1 to 5:1; (f) allowing the first intermediate polar solvent solubilized resin phase to flow out of the first intermediate fractionator primary vessel; (g) allowing the first intermediate non-polar solvent viscous rubber phase to flow out of the first intermediate fractionator primary vessel; (h) adding a combination of a second washing solution comprising polar solvent and non-polar solvent and the first intermediate non-polar solvent viscous rubber phase to the second intermediate fractionator primary vessel to form a second co-solvent based miscella mixture and allowing for separation of the second co-solvent based miscella mixture into (i) a second intermediate non-polar solvent viscous rubber phase in a lower portion of the second intermediate fractionator primary vessel and (ii) a second intermediate polar solvent solubilized resin phase above the second intermediate non-polar solvent viscous rubber phase, wherein the second washing solution comprises about 40 to about 80% by weight of polar solvent based upon the total weight of the second washing solution, and the second washing solution is added in an amount sufficient to provide a weight ratio of second washing solution to non-polar solvent viscous rubber phase from the second fractionator primary vessel of 0.5:1 to 5:1; (i) allowing the second intermediate polar solvent solubilized resin phase to flow out of the second intermediate fractionator primary vessel; (j) allowing the second intermediate non-polar solvent viscous rubber phase to flow out of the second intermediate fractionator primary vessel; (k) adding a combination of a third washing solution comprising polar solvent and non-polar solvent and the second intermediate non-polar solvent viscous rubber phase to the final fractionator primary vessel to form a final co-solvent based miscella mixture and allowing for separation of the final co-solvent based miscella mixture into (i) a final non-polar solvent viscous rubber phase in a lower portion of the final fractionator primary vessel and (ii) a final polar solvent solubilized resin phase above the final non-polar solvent viscous rubber phase, wherein the third washing solution comprises about 40 to about 80% by weight of polar solvent based upon the total weight of the third washing solution, and the third washing solution is added in an amount sufficient to provide a weight ratio of third washing solution to non-polar solvent viscous rubber phase from the third fractionator primary vessel of 0.5:1 to 5:1; (l) allowing the final polar solvent solubilized resin phase to flow out of the final fractionator primary vessel; (m) allowing the final non-polar solvent viscous rubber phase to flow out of the final fractionator primary vessel, thereby providing a separated solubilized rubber phase with reduced resin and polar solvent content as compared to the initial co-solvent based miscella and wherein the separated solubilized rubber phase contains about 75 to about 85% by weight solvents based upon the total weight of the separated solubilized rubber phase; and (n) removing solvent from the separated solubilized rubber phase to produce a purified guayule rubber having a solvent content of no more than 0.5% by weight.

### Initial Co-Solvent Based Miscella and Separation Thereof

As discussed above, according to the process of the second embodiment, an initial co-solvent based miscella is provided which comprises at least one polar solvent in an amount of about 55 to about 70% by weight or 55 to 70% (e.g., 55, 56, 58, 60, 62, 64, 65, 66, 68, or 70%) by weight (based upon the total weight of solvents in the initial co-solvent based miscella), at least one non-polar solvent, solubilized guayule rubber, and solubilized resin. In preferred embodiments of the second embodiment, the initial co-solvent based miscella comprises at least one polar solvent in an amount of about 60 to about 70% or 60 to 70% (e.g., 60, 62, 64, 65, 66, 68, or 70%) by weight, more preferably about 62 to about 68% or 62 to 68% (e.g., 62, 63, 64, 65, 66, 67, or 68%) by weight based upon the total weight of solvents in the initial co-solvent based miscella. According to the process of the second embodiment, the relative amounts of the at least one non-polar solvent, solubilized guayule rubber, and solubilized resin may vary.

In certain embodiments of the process of the second embodiment, the initial co-solvent based miscella is prepared by adding at least one polar solvent to a precursor co-solvent based miscella in an amount sufficient to increase the polar solvent content to about 55 to about 70% or 55 to 70% (e.g., 55, 56, 58, 60, 62, 64, 65, 66, 68, or 70%) by weight based upon the total weight of solvents in the initial co-solvent based miscella, wherein the precursor co-solvent based miscella comprises about 1 to about 8% or 1 to 8% (e.g., 1%, 2%, 3%, 4%, 5%, 6%, 7%, or 8%), preferably about 2 to about 6% or 2 to 6% (e.g., 2%, 3%, 4%, 5%, or 6%), more preferably about 2 to about 5% or 2 to 5% (e.g., 2%, 3%, 4%, or 5%) by weight rubber based upon the total weight of the precursor co-solvent based miscella; about 2 to about 12% or 2 to 12% (e.g., 2, 4, 6, 8, 10 or 12%), preferably about 3 to about 10% or 3 to 10% (e.g., 3%, 4%, 5%, 6%, 7%, 8%, 9%, or 10%), more preferably about 4 to about 8% or 4 to 8% (e.g., 4%, 5%, 6%, 7%, or 8%) by weight resin; about 60 to about 90% or 60 to 90% (e.g., 60%, 65%, 70%, 75%, 80%, 85%, or 90%), preferably about 70 to about 85% or 70 to 85% (e.g., 70%, 72%, 74%, 75%, 76%, 78%, 80%, 82%, 84%, or 85%), more preferably about 70 to about 80% or 70 to 80% (e.g., 70%, 72%, 74%, 76%, 78%, or 80%) by weight non-polar solvent based upon the total weight of solvents in the precursor co-solvent based miscella; and about 10 to about 40% or 10 to 40% (e.g., 10%, 15%, 20%, 25%, 30%, 35%, or 40%), preferably about 15 to about 30% or 15 to 30% (e.g., 15%, 16%, 18%, 20%, 22%, 24%, 25%, 26%, 28% or 30%), more preferably about 20 to about 30% or 20 to 30% (e.g., 20%, 22%, 24%, 25%, 26%, 28%, or 30%) by weight polar solvent based upon the total weight of solvents in the precursor co-solvent based miscella. The source of the precursor co-solvent based miscella may vary, but is generally envisioned as resulting from co-solvent extraction of rubber and resin guayule plant matter (which will generally use at least one polar solvent to solubilize guayule resin and at least one non-polar solvent to solubilize guayule rubber).

In other embodiments of the second embodiment, the concentrations of rubber and resin in the precursor co-solvent based miscella are relatively higher. According to such an embodiment, the initial co-solvent miscella is prepared by adding polar solvent to a precursor co-solvent based miscella in an amount sufficient to increase the polar solvent content to about 55 to about 70% or 55 to 70% (e.g., 55, 56, 58, 60, 62, 64, 65, 66, 68, or 70%), preferably to increase the polar solvent content to about 60 to about 70% or 60 to 70% (e.g., 60, 62, 64, 65, 66, 68, or 70%) by weight, more preferably about 62 to about 68% or 62 to 68% (e.g., 62, 63, 64, 65, 66, 67, or 68%) by weight based upon the total weight of solvents in the initial co-solvent based miscella, and wherein the precursor co-solvent based miscella comprises about 3 to about 20% or 3 to 20% (e.g., 3%, 5%, 7%, 9%, 10%, 11%, 13%, 15%, 17%, 19%, or 20%), preferably about 5 to about 15% or 5 to 15% (e.g., 5%, 6%, 7%, 8%, 9%, 10%, 11%, 12%, 13%, 14%, or 15%), more preferably about 5 to about 12% or 5 to 12% (e.g,, 5%, 6%, 7%, 8%, 9%, 10%, 11%, or 12%) by weight rubber based upon the total weight of the precursor co-solvent based miscella; about 5 to about 30% or 5 to 30% (e.g., 5%, 10%, 15%, 20%, 25%, or 30%), preferably about 6 to about 25% or 6 to 25% (e.g., 6%, 8%, 10%, 12%, 14%, 15%, 16%, 18%, 20%, 22%, 24%, or 25%), more preferably about 8 to about 20% or 8 to 20% (e.g., 8%, 10%, 12%, 14%, 15%, 16%, 18%, or 20%) by weight resin based upon the total weight of the precursor co-solvent based miscella; about 60 to about 90% or 60 to 90% (e.g., 60%, 65%, 70%, 75%, 80%, 85%, or 90%), preferably about 70 to about 85% or 70 to 85% (e.g., 70%, 72%, 74%, 75%, 76%, 78%, 80%, 82%, 84%, or 85%), more preferably about 70 to about 80% or 70 to 80% (e.g., 70%, 72%, 74%, 76%, 78%, or 80%) by weight non-polar solvent based upon the total weight of solvents in the precursor co-solvent based miscella; and about 10 to about 40%, preferably about 15 to about 30, more preferably about 20 to about 30% by weight polar solvent based upon the total weight of solvents in the precursor co-solvent based miscella. Generally, when a more concentrated precursor co-solvent based miscella is utilized, the concentration of resin in each of the respective polar solvent solubilized resin phases will be somewhat higher such as about 3 to about 15% or 3 to 15% (e.g., 3%, 5%, 7%, 9%, 10%, 11%, 13%, or 15%), preferably about 4 to about 12% or 4 to 12% (e.g., 4%, 6%, 8%, 10%, or 12%) by weight based upon the total weight of the polar solvent solubilized resin phase, although the concentration of rubber in each of the respective non-polar solvent viscous rubber phases may be within the ranges discussed infra rather than being higher.

As discussed above, the initial co-solvent miscella is fed into the primary vessel of a first fractionator. In certain embodiments, the initial co-solvent miscella is fed into the primary vessel through an inlet, which is referred to herein as the first fractionator primary vessel feed inlet. Within the primary vessel of the first fractionator, this initial co-solvent miscella is allowed to separate into (i) a non-polar solvent viscous rubber phrase (which is referred to herein as a first non-polar solvent viscous rubber phase) and (ii) a polar solvent solubilized resin phase (which is referred to herein as a first polar solvent solubilized resin phase). According to the process of the second embodiment, the first non-polar solvent viscous rubber phase will form in a lower portion of the first fractionator primary vessel with the first polar solvent viscous resin phase positioned above. Without being bound by theory, the relative positioning of the rubber phase as compared to the resin phase is believed to be based upon the density caused by the solubilized rubber. Thus, according to the process of the second embodiment, the first non-polar solvent viscous rubber phase will generally flow out of the first fractionator primary vessel (which can be understood as being positioned in the lower portion of the first fractionator primary vessel) and then into a first intermediate fractionator primary vessel.

It should also be understood that the phrases “non-polar solvent viscous rubber phase” and “polar solvent solubilized resin phase” (whether used in connection with the first, first intermediate, second intermediate, or final such phases) refers to the primary solvent component of the respective phase. In other words, the primary component (in terms of weight percentage) of any of the non-polar solvent viscous rubber phases will be non-polar solvent, although polar solvent will also be present. Additionally, a small amount of solubilized (low molecular weight) rubber may also be present in the polar solvent solubilized resin phase (due to the presence of some non-polar solvent), although the amount of solubilized rubber in this phase will be considerably less than the amount of solubilized resin. In certain embodiments of the second embodiment, the first non-polar solvent viscous rubber phase will contain about 51 to about 60% or 51 to 60% (e.g., 51%, 52%, 53%, 54%, 55%, 56%, 57%, 58%, 59%, or 60%), preferably about 51 to about 55% or 51 to 55% (e.g., 51%, 52%, 53%, 54%, or 55%) by weight non-polar solvent based upon the total weight of solvents in the first non-polar solvent viscous rubber phase; about 40 to about 49% or 40 to 49% (e.g., 40%, 41%, 42%, 43%, 44%, 45%, 46%, 47%, 48%, or 49%), preferably about 45 to about 49% or 45 to 49% (e.g., 45%, 46%, 47%, 48%, or 49%) by weight polar solvent based upon the total weight of solvents in the first non-polar solvent viscous rubber phase; and about 20 to about 40% or 20 to 40% (e.g., 20%, 22%, 24%, 25%, 26%, 28%, 30%, 32%, 34%, 35%, 36%, 38%, or 40%) by weight, preferably about 25 to about 35% or 25 to 35% (e.g., 25%, 26%, 27%, 28%, 29%, 30%, 31%, 32%, 33%, 34%, or 35%) by weight solids based upon the total weight of the first non-polar solvent viscous rubber phase. Of the solids in the first non-polar solvent viscous rubber phase (as it exits the first fractionator), at least 88% (e.g., 88%, 90%, 92%, 94%, 96%, etc.), preferably at least 90% (e.g., 90%, 91%, 92%, 93%, 94%, 95%, 96%, etc.), more preferably at least 92% (e.g., 92%, 93%, 94%, 95%, 96%, etc.) by weight of the total solids is rubber (with the remainder comprising resin). In certain embodiments of the second embodiment, the first polar solvent solubilized resin phase will contain about 55 to about 70% or 55 to 70% (e.g., 55%, 56%, 57%, 58%, 59%, 60%, 61%, 62%, 63%, 64%, 65%, 66%, 67%, 68%, 69% or 70%), preferably about 60 to about 70% or 60 to 70% (e.g., 60%, 61%, 62%, 63%, 64%, 65%, 66%, 67%, 68%, 69%, or 70%), more preferably about 62 to about 67% or 62 to 67% (e.g., 62%, 63%, 64%, 65%, 66%, or 67%) by weight polar solvent based upon the total weight of solvents in the first polar solvent solubilized resin phase; about 30 to about 45% or 30 to 45% (e.g., 30%, 31%, 32%, 33%, 34%, 35%, 36%, 37%, 38%, 39%, 40%, 41%, 42%, 43%, 44%, or 45%), preferably about 30 to about 40% or 30 to 40% (e.g., 30%, 31%, 32%, 33%, 34%, 35%, 36%, 37%, 38%, 39%, or 40%), more preferably about 33 to about 38% or 33 to 38% (e.g., 33%, 34%, 35%, 36%, 37%, or 38%) by weight non-polar solvent based upon the total weight of solvents in the first polar solvent solubilized resin phase; and about 1 to about 6% or 1 to 6% solids (e.g., 1%, 2%, 3%, 4%, 5%, or 6%), preferably about 1 to about 5% or 1 to 5% solids (e.g., 1%, 2%, 3%, 4%, or 5%), more preferably about 2 to about 4% or 2 to 4% (e.g., 2%, 3%, or 4%) by weight solids based upon the total weight of the first polar solvent solubilized resin phase. Of the solids in the first polar solvent solubilized resin phase, (as it exits the first fractionator), at least 88% (e.g., 88%, 90%, 92%, 94%, 96%, etc.), preferably at least 90% (e.g., 90%, 91%, 92%, 93%, 94%, 95%, 96%, etc.), more preferably at least 92% (e.g., 92%, 93%, 94%, 95%, 96%, etc.) by weight of the total solids is resin (with the remainder comprising low molecular weight rubber). As discussed in more detail below, in preferred embodiments of the process of the second embodiment, the composition of the other polar solvent solubilized resin phases (e.g., the first intermediate polar solvent solubilized resin phase, the second intermediate polar solvent solubilized resin phase, and the final polar solvent solubilized resin phase) as well as the composition of the other non-polar solvent viscous rubber phases (e.g., the first intermediate non-polar solvent viscous rubber phase, the second intermediate non-polar solvent viscous rubber phase, and the final non-polar solvent viscous rubber phase) will be the same or similar to as the first polar solvent solubilized resin phase and first non-polar solvent viscous rubber phases, respectively, as discussed above. At a minimum, each resin phase will include primarily polar solvent, along with non-polar solvent, solubilized rubber and some solubilized rubber (primarily in the form of low molecular weight rubber)

### Fractionation System

As mentioned above, the process of the second embodiment makes use of a fractionation system. Generally, according to the second embodiment, this fractionation system includes (comprises) multiple fractionators connected in series which fractionators are used to separate the initial co-solvent based miscella into at least two phases (through progressive use of each fractionator). According to the second embodiment, the multiple fractionators connected in series include a first fractionator, at least two intermediate fractionators (i.e., a first intermediate fractionator and a second intermediate fractionator), and a final fractionator, and each fractionator comprises a primary vessel (i.e., a first fractionator primary vessel, a first intermediate fractionator primary vessel, a second intermediate fractionator primary vessel, and a final fractionator primary vessel). In certain embodiments of the second embodiment, additional intermediate fractionators can be used (e.g., a third intermediate fractionator, a fourth intermediate fractionator, etc.) which should be understood as including the same components as the other intermediate fractionators (e.g., a primary vessel). According to the second embodiment disclosed herein, particular details as to the configuration of the fractionation system, including, but not limited to the first fractionator, the first intermediate fractionator, the second intermediate fractionator, and the final fractionator, may vary. In certain embodiments of the second embodiment, the fractionation system, including, but not limited to the first fractionator, the first intermediate fractionator, the second intermediate fractionator, and the final fractionator has a configuration according to one or more embodiments disclosed in U.S. Patent Application Publication No. 2017-024655A1, application Ser. No. 15/512,150, filed Mar. 17, 2017, entitled “Fractionator For Separating Solubilized Rubber From A Co-Solvent Based Miscella And Related Processes” and claiming priority to provisional patent application 62/052,944 filed Sep. 19, 2014, the disclosure of each of which is incorporated herein by reference.

In certain embodiments of the process of the second embodiment, the primary vessel of at least one fractionator in the fractionation system, preferably the primary vessel of each fractionator includes a feed inlet and a bottom outlet. According to such embodiments, the feel inlet can be utilized to add ingredients (such as the initial co-solvent based miscella, a respective non-polar solvent viscous rubber phase from the previous fractionator, and/or a respective washing solution) to the primary vessel of a fractionator. Similarly, according to such embodiments, the bottom outlet can be used to remove the respective non-polar solvent viscous rubber phase from the respective fractionator by allowing the rubber phase to flow out through the bottom outlet. In certain embodiments of the process of the second embodiment, the primary vessel of at least one fractionator in the fractionation system, preferably the primary vessel of each fractionator (e.g., the first fractionator, the first intermediate fractionator, the second intermediate fractionator, and the final fractionator), also includes a side outlet through which the respective polar solvent solubilized resin phase flows out of the respective fractionator during (c), (f), (i), and (l). In preferred embodiments of the second embodiment, the side outlet of the primary vessel of at least one fractionator in the fractionation system, preferably the primary vessel of each fractionator, is positioned in the primary vessel in its upper portion such that the side outlet is suitable for removing material from the upper portion of the primary vessel (i.e., suitable for removing the polar solvent solubilized resin phase from the primary vessel). As discussed further herein, during separation of phases in a respective fractionator primary vessel, the polar solvent solubilized resin phase will form above the non-polar solvent viscous rubber phase. Accordingly, positioning of the side outlet so as to allow removal of the polar solvent solubilized resin phase from the primary vessel (through the side outlet) is advantageous.

In certain embodiments of the process of the second embodiment, the primary vessel of at least one fractionator in the fractionation system, preferably the primary vessel of each fractionator (e.g., the first fractionator, the first intermediate fractionator, the second intermediate fractionator, and the final fractionator), also includes an internal weir which is located between the interior of the primary vessel and the side outlet, and over which internal weir the respective polar solvent solubilized resin phase flows to exit the respective fractionator through its respective side outlet during (c), (f), (i), and (l). In certain embodiments of the second embodiment, the side outlet is bounded by the internal weir such that the polar solvent solubilized resin phase must flow over the internal weir for removal through the side outlet. In other words, in such embodiments the internal weir provides an interior barrier to the side outlet that must be overcome before the polar solvent solubilized resin phase can be removed from the primary vessel (110) through the side outlet. Thus, it can be appreciated that the internal weir assists in controlling the phase interface level (which can be understood as line of separation between the non-polar solvent viscous rubber phase and the polar solvent solubilized resin phase) in the primary vessel. In those embodiments of the second embodiment where a side outlet and internal weir are present, the side outlet and internal weir combination can improve the operation of the fractionator by allowing the fractionator to operate without a liquid full volume and by providing better control of the phase interface level. In other embodiments of the second embodiment, no internal weir is present but each fractionator is connected to an external side tank which is fluidly connected to the primary vessel of the fractionator and capable of containing the respective polar solvent solubilized resin phase when it flows out of the respective fractionator.

In certain embodiments of the second embodiment when the internal weir is present, the internal weir forms a wall around a portion of the circumference of an upper interior portion of the primary vessel in which the internal weir is present. Alternatively, in certain embodiments of the second embodiment when the internal weir is present, the internal weir forms a wall around the entire circumference of an upper interior portion of the primary vessel. In such embodiments, a feed inlet that feeds the co-solvent based miscella (or the non-polar solvent viscous rubber phase) is positioned so that it feeds material into the interior of the primary vessel and not into the internal weir. As previously mentioned, the internal weir functions to separate the side outlet from the interior volume of the primary vessel which is occupied by liquid (i.e., the separating co-solvent based miscella) until the level of the polar solvent solubilized resin phase overcomes the internal weir to allow at least a portion of the polar solvent solubilized resin phase to flow from the primary vessel through the side outlet. In certain embodiments of the second embodiment, at least a majority of the polar solvent solubilized resin phase, and preferably substantially all of the polar solvent solubilized resin phase (i.e., at least 90% by volume) is removed from the respective fractionator primary vessel in this manner. As discussed elsewhere herein, it should be understood that a relatively minor amount of polar solvent and solubilized resin may remain associated with the non-polar solvent viscous rubber phase.

In certain embodiments of the second embodiment, at least one fractionator, preferably each fractionator, is fluidly connected with an external side tank which is capable of receiving the respective polar solvent solubilized resin phase which flows out of the respective fractionator primary vessel. According to such embodiments, the external side tank is preferably fluidly connected in the upper portion of the primary vessel since this is where the polar solvent solubilized resin phase forms.

In certain embodiments of the second embodiment, the fractionation system includes one or more mixers which are fluidly connected with and positioned upstream of at least one, or preferably each, fractionator and used to achieve mixing prior to flow into the respective fractionator. In preferred embodiments of the second embodiment, each fractionator (e.g., the first fractionator, the first intermediate fractionator, the second intermediate fractionator, and the final fractionator) has a mixer which is fluidly connected thereto and positioned upstream of the respective fractionator to allow for mixing prior to flow into the respective fractionator. These mixers can be referred to as first mixer, first intermediate mixer, second intermediate mixer, and final mixer. In certain embodiments of the second embodiment, the mixer or mixers are static mixers (with no moving parts) and in other embodiments of the second embodiment, the mixer or mixers are active mixers (which can be understood as including a motorized mixing apparatus). In those embodiments of the second embodiment wherein a mixer or mixers is utilized, the respective washing solution and respective non-polar solvent viscous rubber phase are preferably combined prior to being added to the mixer (or for the mixer preceding the first fractionator any precursor co-solvent based miscella and polar solvent are preferably combined prior to being added to the first mixer). In certain embodiments of the second embodiment, the initial co-solvent based miscella is fed through a heat exchanger (which may be heated or cooled with appropriate plant utilities such as hot water or cooling water)) and/or a mixer prior to being fed into the primary vessel of the first fractionator. Any mixing employed via the mixer or mixers will generally avoid aggressive mixing of the combined stream of the polar solvent and the initial co-solvent based miscella or of the washing solution and non-polar solvent viscous rubber phase, which aggressive mixing could otherwise lead to problems in achieving the desired phase separation in the fractionators. In certain embodiments of the second embodiment, a precursor co-solvent miscella combined with polar solvent flows through a first s mixer for mixing prior to entering the first fractionator primary vessel. In certain embodiments of the second embodiment, the non-polar solvent viscous rubber phase from the first fractionator combined with the first washing solution flows through a first intermediate mixer for mixing prior to entering the first intermediate fractionator primary vessel. In certain embodiments of the second embodiment, the non-polar solvent viscous rubber phase from the first intermediate fractionator combined with the second washing solution flows through a second intermediate mixer for mixing prior to entering the second intermediate fractionator primary vessel. In certain embodiments of the second embodiment, the non-polar solvent viscous rubber phase from the second intermediate fractionator combined with the third washing solution flows through a final mixer for mixing prior to entering the final fractionator primary vessel. In embodiments of the second embodiment such as those discussed above wherein a mixer is positioned before each of the fractionators, the initial co-solvent based miscella or respective non-polar solvent viscous rubber phase and polar solvent or respective washing solution, respectively, can be considered to be added to their respective fractionator primary in a pre-mixed form such as by use of the respective mixer.

As discussed above, the process of the second embodiment makes use of a washing solution, which includes at least a first washing solution, a second washing solution, and a third washing solution which are added to the first intermediate fractionator primary vessel, the second intermediate fractionator primary vessel, and the final fractionator primary vessel, respectively. Generally, each washing solution can be understood as useful in removing resin (and other polar-soluble moieties) from a non-polar solvent viscous rubber phase. In other words, by use of the respective washing solution, the amount of resin that is present in a respective non-polar solvent viscous rubber phase can be reduced. As a non-limiting example, use of the first washing solution in the first intermediate fractionator will result in the first intermediate non-polar solvent viscous rubber phase which exits the first intermediate fractionator having a lower amount of resin (in terms of weight percentage of the overall viscous rubber phase) than the first non-polar solvent viscous phase which was initially added to the first intermediate fractionator.

According to the process of the second embodiment, each washing solution (e.g., the first washing solution, the second washing solution, and the third washing solution) comprises a combination of polar solvent and non-polar solvent. In certain embodiments of the second embodiment, each washing solution (e.g., the first washing solution, the second washing solution, and the third washing solution) consists of a combination of polar solvent and non-polar solvent. In other words, in such embodiments, the only ingredients of each washing solution are the combination of polar and non-polar solvents. According to the second embodiment, each washing solution can comprise (include) a combination of one or more than one polar solvent (e.g., two polar solvents, three polar solvents, etc.) and one or more than one non-polar solvent (e.g., two non-polar solvents, three non-polar solvents, etc.). In preferred embodiments of the second embodiment, each washing solution comprises only one polar solvent in combination with at least one non-polar solvent. In preferred embodiments of the second embodiment, the polar solvent in each of the washing solutions (e.g., the first washing solution, the second washing solution, and the third washing solution) is identical and the non-polar solvent is identical in each of the washing solutions (e.g., the first washing solution, the second washing solution, and the third washing solution), i.e., the polar and non-polar solvents in each of the first washing solvent, the second washing solvent, and the third washing solvent are identical.

According to the process of the second embodiment, the composition of each washing solution (e.g., the first washing solution, the second washing solution, and the third washing solution) can vary in terms of the relative amount of polar solvent versus non-polar solvent in each washing solution. In certain embodiments of the second embodiment, the composition of each washing solution (e.g., the first washing solution, the second washing solution, and the third washing solution) is the same in terms of the relative amount of polar solvent versus non-polar solvent, i.e., the amount of polar solvent (and non-polar solvent) in each of the first washing solvent, the second washing solvent, and the third washing solvent is identical. In other embodiments of the second embodiment, the composition of each washing solution (e.g., the first washing solution, the second washing solution, and the third washing solution) changes from the first to the second to the third, with the amount (concentration) of polar solvent decreasing by about 1 to about 5% or 1 to 5% by weight (e.g., 1%, 2%, 3%, 4% or 5% by weight), based upon the total weight of solvents in the washing solution) in each successive washing solution. In other embodiments of the second embodiment, the composition of each washing solution (e.g., the first washing solvent, the second washing solvent, and the third washing solution) is the same in terms of the relative amount of polar solvent versus non-polar solvent. In certain embodiments of the second embodiment, the first washing solution comprises about 40% to about 80% by weight or 40% to 80% by weight (e.g., 40%, 45%, 50%, 55%, 60%, 65%, 70%, 75%, or 80% by weight) of polar solvent based upon the total weight of solvents in the first washing solution. In certain embodiments of the second embodiment, the second washing solution comprises about 40% to about 80% by weight or 40% to 80% by weight (e.g., 40%, 45%, 50%, 55%, 60%, 65%, 70%, 75%, or 80% by weight) of polar solvent based upon the total weight of solvents in the second washing solution. In certain embodiments of the second embodiment, the third washing solution comprises about 40% to about 80% by weight or 40% to 80% by weight (e.g., 40%, 45%, 50%, 55%, 60%, 65%, 70%, 75%, or 80% by weight) of polar solvent based upon the total weight of solvents in the third washing solution. In certain preferred embodiments of the second embodiment, each washing solution (e.g., the first washing solution, the second washing solution, and the third washing solution) comprises about 40% to about 80% by weight or 40% to 80% by weight (e.g., 40%, 45%, 50%, 55%, 60%, 65%, 70%, 75%, or 80% by weight) of polar solvent based upon the total weight of solvents in the respective washing solution. In certain embodiments of the second embodiment, the first washing solution comprises about 48% to about 65% by weight or 48% to 65% by weight (e.g., 48%, 50%, 52%, 54%, 55%, 56%, 58%, 60%, 62%, 64%, or 65%, by weight) of polar solvent based upon the total weight of solvents in the first washing solution. In certain embodiments of the second embodiment, the second washing solution comprises about 48% to about 65% by weight or 48% to 65% by weight (e.g., 48%, 50%, 52%, 54%, 55%, 56%, 58%, 60%, 62%, 64%, or 65%, by weight) of polar solvent based upon the total weight of solvents in the second washing solution. In certain embodiments of the second embodiment, the third washing solution comprises about 48% to about 65% by weight or 48% to 65% by weight (e.g., 48%, 50%, 52%, 54%, 55%, 56%, 58%, 60%, 62%, 64%, or 65%, by weight) of polar solvent based upon the total weight of solvents in the third washing solution. In more preferred embodiments of the second embodiment, each washing solution (e.g., the first washing solution, the second washing solution, and the third washing solution) comprises about 48% to about 65% by weight or 48% to 65% by weight (e.g., 48%, 50%, 52%, 54%, 55%, 56%, 58%, 60%, 62%, 64%, or 65%, by weight) of polar solvent based upon the total weight of solvents in the respective washing solution. In certain embodiments of the second embodiment, the first washing solution comprises about 50% to about 60% by weight or 50% to 60% by weight (e.g., 50%, 52%, 54%, 55%, 56%, 58%, or 60% by weight) of polar solvent based upon the total weight of the first washing solution, more preferably about 55% to about 60% by weight or 55% to 60% by weight (e.g., 50%, 51%, 52%, 53%, 54%, or 55% by weight) of polar solvent based upon the total weight of solvents in the first washing solution. In certain embodiments of the second embodiment, the second washing solution comprises about 50% to about 60% by weight or 50% to 60% by weight (e.g., 50%, 52%, 54%, 55%, 56%, 58%, or 60% by weight) of polar solvent based upon the total weight of the second washing solution, more preferably about 55% to about 60% by weight or 55% to 60% by weight (e.g., 50%, 51%, 52%, 53%, 54%, or 55% by weight) of polar solvent based upon the total weight of solvents in the second washing solution. In certain embodiments of the second embodiment, the third washing solution comprises about 50% to about 60% by weight or 50% to 60% by weight (e.g., 50%, 52%, 54%, 55%, 56%, 58%, or 60% by weight) of polar solvent based upon the total weight of the third washing solution, more preferably about 55% to about 60% by weight or 55% to 60% by weight (e.g., 50%, 51%, 52%, 53%, 54%, or 55% by weight) of polar solvent based upon the total weight of solvents in the third washing solution. In even more preferred embodiments of the second embodiment, each washing solution (e.g., the first washing solution, the second washing solution, and the third washing solution) comprises about 50% to about 60% by weight or 50% to 60% by weight (e.g., 50%, 52%, 54%, 55%, 56%, 58%, or 60% by weight) of polar solvent based upon the total weight of the respective washing solution, more preferably about 55% to about 60% by weight or 55% to 60% by weight (e.g., 50%, 51%, 52%, 53%, 54%, or 55% by weight) of polar solvent based upon the total weight of solvents in the respective washing solution.

In certain preferred embodiments of the process of the second embodiment, certain of the washing solutions used in the process are supplied by re-using a polar solvent solubilized resin phase. According to such embodiments, the first washing solution is provided by the polar solvent solubilized resin phase which flows out of the second intermediate fractionator primary vessel or the second washing solution is provided by the polar solvent solubilized resin phase which flows out of the final fractionator primary vessel; in certain such embodiments, the first washing solution is provided by the resin phase from the second intermediate fractionator and the second washing solution is provided by the resin phase from the final fractionator. In those embodiments of the second embodiment wherein the first and/or second washing solutions are provided by a separated resin phase, as discussed above, the polar solvent content of each separated resin phase (and accordingly the first and/or second washing solution for which that resin phase is re-used) may vary. Generally, according to preferred embodiments of the second embodiment, when the first washing solution is provided by the resin phase from the second intermediate fractionator, the first washing solution comprises about 51 to about 60% or 51 to 60% by weight polar solvent, based upon the total amount of solvent in the first washing solution. Generally, according to preferred embodiments of the second embodiment, when the second washing solution is provided by the resin phase from the final fractionator, the second washing solution comprises about 51 to about 60% or 51 to 60% by weight polar solvent, based upon the total amount of solvent in the second washing solution.

According to the process of the second embodiment, the amount of each washing solution that is added during the process (e.g., the first washing solution, the second washing solution, and the third washing) to the respective fractionator primary vessel (e.g., the first intermediate fractionator, the second intermediate fractionator, and the final fractionator) may vary. In other embodiments of the process of the second embodiment, the amount of each washing solution that is added during the process (e.g., the first washing solution, the second washing solution, and the third washing) to the respective fractionator primary vessel (e.g., the first intermediate fractionator, the second intermediate fractionator, and the final fractionator) is identical. In preferred embodiments of the second embodiment, the amount of each washing solution that is added during the process (e.g., the first washing solution, the second washing solution, and the third washing) to the respective fractionator primary vessel (e.g., the first intermediate fractionator primary vessel, the second intermediate fractionator primary vessel, and the final fractionator primary vessel) is an amount sufficient to provide a weight ratio of washing solution to non-polar viscous rubber phrase from the previous fractionator primary vessel of 0.5:1 to 5:1 on a weight-to-weight basis (e.g., 0.5:1, 1:1, 1.5:1, 2:1, 2.5:1, 3:1, 3.5:1, 4:1, 4.5:1, or 5:1). For example, with respect to the addition of the first washing solution to the first intermediate fractionator primary vessel, in such an embodiment, the first washing solution is added in an amount sufficient to provide a weight ratio of first washing solution to non-polar solvent viscous rubber phrase from the first fractionator primary vessel of 0.5:1 to 5:1 on a weight-to-weight basis, or an amount within the foregoing range, as mentioned above. Similarly, with respect to the addition of the second washing solution to the second intermediate fractionator primary vessel, in such an embodiment, the second washing solution is added in an amount sufficient to provide a weight ratio of second washing solution to non-polar solvent viscous rubber phrase from the first intermediate fractionator primary vessel of 0.5:1 to 5:1 on a weight-to-weight basis, or an amount within the foregoing range, as mentioned above. And, with respect to the addition of the third washing solution to the final fractionator primary vessel, in such an embodiment, the third washing solution is added in an amount sufficient to provide a weight ratio of third washing solution to non-polar solvent viscous rubber phrase from the second intermediate fractionator primary vessel of 0.5:1 to 5:1 on a weight-to-weight basis, or an amount within the foregoing range, as mentioned above. In more preferred embodiments of the second embodiment, the amount of each washing solution that is added during the process (e.g., the first washing solution, the second washing solution, and the third washing) to the respective fractionator primary vessel (e.g., the first intermediate fractionator primary vessel, the second intermediate fractionator primary vessel, and the final fractionator primary vessel) is an amount sufficient to provide a weight ratio of washing solution to non-polar viscous rubber phrase from the previous fractionator primary vessel of 2:1 to 4:1 on a weight-to-weight basis (e.g., 2:1, 2.5:1, 3:1, 3.5:1, or 4:1). For example, with respect to the addition of the first washing solution to the first intermediate fractionator primary vessel, in such an embodiment, the first washing solution is added in an amount sufficient to provide a weight ratio of first washing solution to non-polar solvent viscous rubber phrase from the first fractionator primary vessel of 2:1 to 4:1 on a weight-to-weight basis, or an amount within the foregoing range, as mentioned above. Similarly, with respect to the addition of the second washing solution to the second intermediate fractionator primary vessel, in such an embodiment, the second washing solution is added in an amount sufficient to provide a weight ratio of second washing solution to non-polar solvent viscous rubber phrase from the first intermediate fractionator primary vessel of 2:1 to 4:1 on a weight-to-weight basis, or an amount within the foregoing range, as mentioned above. And, with respect to the addition of the third washing solution to the final fractionator primary vessel, in such an embodiment, the third washing solution is added in an amount sufficient to provide a weight ratio of third washing solution to non-polar solvent viscous rubber phrase from the second intermediate fractionator primary vessel of 2:1 to 4:1 on a weight-to-weight basis, or an amount within the foregoing range, as mentioned above. In more preferred embodiments of the second embodiment, the amount of each washing solution that is added during the process (e.g., the first washing solution, the second washing solution, and the third washing) to the respective fractionator primary vessel (e.g., the first intermediate fractionator primary vessel, the second intermediate fractionator primary vessel, and the final fractionator primary vessel) is an amount sufficient to provide a weight ratio of washing solution to non-polar viscous rubber phrase from the previous fractionator primary vessel of 3:1 to 4:1 on a weight-to-weight basis (e.g., 3:1, 3.2:1, 3.4:1, 3.5:1, 3.6:1, 3.8:1, or 3:1). For example, with respect to the addition of the first washing solution to the first intermediate fractionator primary vessel, in such an embodiment, the first washing solution is added in an amount sufficient to provide a weight ratio of first washing solution to non-polar solvent viscous rubber phrase from the first fractionator primary vessel of 3:1 to 4:1 on a weight-to-weight basis, or an amount within the foregoing range, as mentioned above. Similarly, with respect to the addition of the second washing solution to the second intermediate fractionator primary vessel, in such an embodiment, the second washing solution is added in an amount sufficient to provide a weight ratio of second washing solution to non-polar solvent viscous rubber phrase from the first intermediate fractionator primary vessel of 3:1 to 4:1 on a weight-to-weight basis, or an amount within the foregoing range, as mentioned above. And, with respect to the addition of the third washing solution to the final fractionator primary vessel, in such an embodiment, the third washing solution is added in an amount sufficient to provide a weight ratio of third washing solution to non-polar solvent viscous rubber phrase from the second intermediate fractionator primary vessel of 3:1 to 4:1 on a weight-to-weight basis, or an amount within the foregoing range, as mentioned above.

### Non-Polar Solvent Viscous Rubber Phase

As should be apparent from the above discussion of the process of the second embodiment, a non-polar solvent viscous rubber phase is produced in each of the fractionators (e.g., within the primary vessel thereof) of the fractionation system. More specifically, a first non-polar solvent viscous rubber phase forms in the first fractionator (and then flows out of the first fractionator into the first intermediate fractionator), a first intermediate non-polar solvent viscous rubber phase forms in the first intermediate fractionator (and then flows out of the first intermediate fractionator into the second intermediate fractionator), a second intermediate non-polar solvent viscous rubber phase forms in the second intermediate fractionator, and then flows out of the second intermediate fractionator into the final fractionator), and a final non-polar solvent viscous rubber phase forms in the final fractionator. As mentioned above, according to the second embodiment, the final non-polar viscous rubber phase which follows out of the final fractionator primary vessel can also be considered a separated solubilized rubber phase (and, as discussed above this separated solubilized rubber phase contains about 75 to about 85% by weight or 75 to 85% by weight solvents based upon the total weight of the separated solubilized rubber phase and 15-25% by weight solids based upon the total weight of the separated solubilized rubber phase. The primary solvent present in the separated solubilized rubber phase (also referred to as the final non-polar solvent viscous rubber phase) will be non-polar solvent, although polar solvent will also be present. In certain embodiments of the second embodiment, the final non-polar solvent viscous rubber phase comprises about 51 to about 60% or 51 to 60% (e.g., 51%, 52%, 53%, 54%, 55%, 56%, 57%, 58%, 59%, or 60%), preferably about 51 to about 55% or 51 to 55% (e.g., 51%, 52%, 53%, 54%, or 55%) by weight non-polar solvent based upon the total weight of solvents in the final non-polar solvent viscous rubber phase; about 40 to about 49% or 40 to 49% (e.g., 40%, 41%, 42%, 43%, 44%, 45%, 46%, 47%, 48%, or 49%), preferably about 45 to about 49% or 45 to 49% (e.g., 45%, 46%, 47%, 48%, or 49%) by weight polar solvent based upon the total weight of solvents in the final non-polar solvent viscous rubber phase. In certain embodiments of the second embodiment, the final non-polar solvent viscous rubber phase may also include very small amounts of bagasse (e.g., less than 1% by weight, preferably less than 0.5% by weight, more preferably less than 0.1% by weight bagasse), based upon the total amount of rubber in the final non-polar solvent viscous rubber phase. In other words, the foregoing amounts of bagasse are weight percentages based upon the weight of the rubber rather than upon the overall weight of the final non-polar solvent viscous rubber phase. The separated solubilized rubber phase or final non-polar solvent viscous rubber phase also includes, i.e., in addition to the solvents, solubilized rubber and a small amount of solubilized resin (referred to collectively as solids). The amount of solids present in the separated solubilized rubber phase or final non-polar solvent viscous rubber phase will vary according to the process of the second embodiment, but will generally be about 15 to about 25% by weight or 15 to 25% by weight (e.g., 15%, 16%, 17%, 18%, 19%, 20%, 21%, 22%, 23%, 24%, or 25% by weight) based upon the total weight of the separated solubilized rubber phase or final non-polar solvent viscous rubber phase. In preferred embodiments of the second embodiment, the amount of solids present in the separated solubilized rubber phase or final non-polar solvent viscous rubber phase is about 17 to about 24% by weight or 17 to 24% by weight (e.g., 17%, 18%, 19%, 20%, 21%, 22%, 23%, or 24% by weight) based upon the total weight of the separated solubilized rubber phase or final non-polar solvent viscous rubber phase.

According to the process of the second embodiment, the solids content of the other non-polar solvent viscous rubber phases (i.e., the first non-polar solvent viscous rubber phase, the second non-polar solvent viscous rubber phase, and the final non-polar solvent viscous rubber phase) may vary. Generally, according to preferred embodiments of the second embodiment, the solids content of each successive viscous rubber phase will decrease by about 1 to about 10% or 1-10%, in each stage. In certain embodiments of the second embodiment, the first non-polar solvent viscous rubber phase will have a solids content of about 20 to about 40% or 20 to 40%, preferably about 25 to about 35% or 25 to 35% by weight solids based upon the total weight of the first non-polar solvent viscous rubber phase. In certain embodiments of the second embodiment, the first intermediate non-polar solvent viscous rubber phase will have a solids content of about 20 to about 35% or 20 to 35%, preferably about 25 to about 30% or 25 to 30% by weight based upon the total weight of the first intermediate non-polar solvent viscous rubber phase. In certain embodiments of the second embodiment, the second intermediate non-polar solvent viscous rubber phase will have a solids content of about 15 to about 30% or 15 to 30%, preferably about 18 to about 28% or 18 to 28% by weight % based upon the total weight of the second intermediate non-polar solvent viscous rubber phase. For each of the foregoing viscous rubber phases, at least 88% (e.g., 88%, 90%, 92%, 94%, 96%, etc.), preferably at least 90% (e.g., 90%, 91%, 92%, 93%, 94%, 95%, 96%, etc.), more preferably at least 92% (e.g., 92%, 93%, 94%, 95%, 96%, etc.) by weight of the total solids is rubber (with the remainder comprising resin). In certain embodiments of the process of the second embodiment, each of the viscous rubber phases has a solids content within one of the foregoing ranges, preferably within one of the foregoing preferred ranges. Generally, as the process of the second embodiment progresses (e.g., from the first fractionator to the second fractionator then to the third fractionator and finally to the final fractionator), the percent solids decrease since additional non-polar solvent will be effectively added at each respective fractionator stage (i.e., from the additions of the respective washing solutions in the second fractionator, third fractionator and final fractionator). As a result of the increase in the non-polar solvent, the non-polar solvent viscous rubber phase becomes less dense as the process of the second embodiment progresses (e.g., the density of the second intermediate non-polar solvent viscous rubber phase is less than the density of the first intermediate non-polar solvent viscous rubber phase). However, it should be understood that the purity of the rubber increases as the process of the second embodiment progresses since with each respective fractionator stage more resin is removed via the polar solvent solubilized resin phases.

In certain embodiments of the second embodiment, at least one of the first non-polar solvent viscous rubber phase, the first intermediate non-polar solvent viscous rubber phase, or the second intermediate non-polar solvent viscous rubber phase, preferably each of these rubber phases, comprises about 51 to about 60% or 51 to 60% (e.g., 51%, 52%, 53%, 54%, 55%, 56%, 57%, 58%, 59%, or 60%), preferably about 51 to about 55% or 51 to 55% (e.g., 51%, 52%, 53%, 54%, or 55%) by weight non-polar solvent based upon the total weight of solvents in the respective non-polar solvent viscous rubber phase; about 40 to about 49% or 40 to 49% (e.g., 40%, 41%, 42%, 43%, 44%, 45%, 46%, 47%, 48%, or 49%), preferably about 45 to about 49% or 45 to 49% (e.g., 45%, 46%, 47%, 48%, or 49%) by weight polar solvent based upon the total weight of solvents in the respective non-polar solvent viscous rubber phase.

In certain embodiments of the process of the second embodiment, the process includes a further step of recovering the purified guayule rubber from the separated solubilized rubber phase (or final non-polar solvent viscous rubber phase) which exits the final fractionator primary vessel. In such embodiments, the resulting purified guayule rubber can be recovered from using conventional methods, including but not limited to desolventization, coagulation with an alcohol, filtration, purification, and other forms of drying. Non-limiting forms of desolventization include, but are not limited to, methods including screw extrusion, heat and/or application of vacuum. Generally, once the purified guayule rubber has been recovered from the solvents present in the separated solubilized rubber phase (or final non-polar solvent viscous rubber phase), only a very small amount of solvent(s) will remain in the purified guayule rubber, e.g., no more than about 0.5% by weight, preferably no more than about 0.1% by weight.

### Polar Solvent Solubilized Resin Phase

As should be apparent from the above discussion of the process of the second embodiment, a polar solvent solubilized resin phase is produced in each of the fractionators of the fractionation system. More specifically, a first polar solvent solubilized resin phase forms in the first fractionator, a first intermediate polar solvent solubilized resin phase forms in the first intermediate fractionator, a second intermediate polar solvent solubilized resin phase forms in the second intermediate fractionator, and a final polar solvent solubilized resin phase forms in the final fractionator. According to the second embodiment, the final polar solubilized resin phase which flows out of the final fractionator primary vessel generally contains a high percentage of solvent. In certain embodiments of the second embodiment, the final polar solvent solubilized resin phase contains at least 90% by weight solvents (e.g., 90%, 91%, 92%, 93%, 94%, 95%, 96%, 97%, 98%, 99%, etc.) based upon the total weight of the final polar solvent solubilized resin phase with the remaining amount (to account for 100% in total) comprising solids (i.e., mostly resin but with some low molecular weight rubber, as discussed infra). In certain embodiments of the second embodiment, the final polar solvent solubilized resin phase contains about 96 to about 98% or 96 to 98% by weight solvents (e.g., 96%, 96.5%, 97%, 97.5%, 98%) based upon the total weight of the final polar solvent solubilized resin phase with the remaining amount (to account for 100% in total) comprising solids. In other embodiments of the second embodiment, the final polar solvent solubilized resin phase contains about 88 to about 95% or 88 to 95% by weight solvents (e.g., 88%, 89%, 90%, 91%, 92%, 93%, 94%, or 95%) based upon the total weight of the final polar solvent solubilized resin phase with the remaining amount (to account for 100% in total) comprising solids. The primary solvent present in the final polar solvent solubilized resin phase will be polar solvent, although non-polar solvent is also present. The final polar solvent solubilized resin phase also includes, i.e., in addition to the solvents, solubilized resin and a small amount of low molecular weight solubilized rubber (referred to collectively as solids). Generally, according to the second embodiment, the final polar solvent solubilized resin phase will contain about 55 to about 70% or 55 to 70% (e.g., 55%, 56%, 57%, 58%, 59%, 60%, 61%, 62%, 63%, 64%, 65%, 66%, 67%, 68%, 69% or 70%), preferably about 60 to about 70% or 60 to 70% (e.g., 60%, 61%, 62%, 63%, 64%, 65%, 66%, 67%, 68%, 69%, or 70%), more preferably about 62 to about 67% or 62 to 67% (e.g., 62%, 63%, 64%, 65%, 66%, or 67%) by weight polar solvent based upon the total weight of solvents in the final polar solvent solubilized resin phase; about 30 to about 45% or 30 to 45% (e.g., 30%, 31%, 32%, 33%, 34%, 35%, 36%, 37%, 38%, 39%, 40%, 41%, 42%, 43%, 44%, or 45%), preferably about 30 to about 40% or 30 to 40% (e.g., 30%, 31%, 32%, 33%, 34%, 35%, 36%, 37%, 38%, 39%, or 40%), more preferably about 33 to about 38% or 33 to 38% (e.g., 33%, 34%, 35%, 36%, 37%, or 38%) by weight non-polar solvent based upon the total weight of solvents in the final polar solvent solubilized resin phase; and about 2 to about 4% or 2 to 4% (e.g., 2%, 2.5%, 3%, 3.5%, or 4%) by weight, preferably about 2 to about 3% or 2 to 3% (e.g., 2%, 2.2%, 2.4%, 2.5%, 2.6%, 2.8%, or 3%) by weight solids based upon the total weight of the final polar solvent solubilized resin phase. Of the solids in the final polar solvent solubilized resin phase (as it exits the final fractionator), at least 88% (e.g., 88%, 90%, 92%, 94%, 96%, etc.), preferably at least 90% (e.g., 90%, 91%, 92%, 93%, 94%, 95%, 96%, etc.), more preferably at least 92% (e.g., 92%, 93%, 94%, 95%, 96%, etc.) by weight of the total solids is resin (with the remainder comprising low molecular weight rubber).

According to the process of the second embodiment, the solids content of the other polar solvent solubilized resin phases (i.e., the first polar solvent solubilized resin phase, the first intermediate polar solvent solubilized resin phase, and the second intermediate polar solvent solubilized resin phase) may vary. In certain embodiments of the second embodiment, the first polar solvent solubilized resin phase will have a solids content of about 1 to about 6% or 1 to 6% by weight (e.g., 1%, 2%, 3%, 4%, 5%, or 6%), preferably about 2 to about 5% or 2 to 5% by weight (e.g., 2%, 3%, 4%, or 5%), based upon the total weight of the first polar solvent solubilized resin phase; in certain such embodiments, at least 88%, more preferably at least 92% by weight of the total solids is resin (with the remainder comprising low molecular weight rubber. In certain embodiments of the second embodiment, the first intermediate polar solvent solubilized resin phase will have a solids content of about 1 to about 5% or 1 to 5% (e.g., 1%, 2%, 3%, 4%, or 5%) by weight %, preferably about 1 to about 4% or 1 to 4% (e.g., 1%, 2%, 3%, or 4%) by weight %, based upon the total weight of the first intermediate polar solvent solubilized resin phase; in certain such embodiments, at least 88%, more preferably at least 92% by weight of the total solids is resin (with the remainder comprising low molecular weight rubber). In certain embodiments of the second embodiment, the second intermediate polar solvent solubilized resin phase will have a solids content of about 0.5 to about 4% or 0.5 to 4% (e.g., 0.5%, 1%, 2%, 3%, or 4%) by weight %, preferably about 0.5 to about 3% or 0.5 to 3% (e.g., 0.5%, 1%, 2%, or 3%) by weight %, based upon the total weight of the second intermediate polar solvent solubilized resin phase; in certain such embodiments, at least 88% (e.g., 88%, 89%, 90%, 91%, 92%, 93%, 94%, 95%, 96%, 97%, 98%, etc.), more preferably at least 92% (e.g., 92%, 93%, 94%, 95%, 96%, 97%, 98%, etc.) by weight of the total solids is resin (with the remainder comprising low molecular weight rubber). As the process of the second embodiment progresses (e.g., from the first fractionator to the second fractionator, then to the third fractionator and finally to the final fractionator), the percent solids decrease to a certain extent (e.g., by about 0.5 to about 2%) since additional polar solvent will be effectively added at each respective fractionator stage (i.e., from the additions of the respective washing solutions in the second fractionator, third fractionator and final fractionator). As a result of the increase in the polar solvent, the polar solvent solubilized resin phase becomes less dense as the process of the second embodiment progresses (e.g., the density of the final polar solvent solubilized resin phase is less than the density of the second polar solvent solubilized resin phase).

### Polar Solvent

As mentioned above, according to the process of the second embodiment, at least one polar solvent is present in various stages of the process. More specifically, as discussed above, the initial co-solvent miscella comprises at least one polar solvent (in addition to at least one non-polar solvent, solubilized guayule rubber, and solubilized resin), the first washing solution comprises polar solvent (and non-polar solvent), the second washing solution comprises polar solvent (and non-polar solvent), the third washing solution comprises polar solvent (and non-polar solvent). And, in certain embodiments of the second embodiment, at least one polar solvent is added to a precursor co-solvent based miscella to form an initial co-solvent based miscella. In certain preferred embodiments of the second embodiment, the polar solvent present in the first washing solution (i.e., in step (e), as discussed herein), in the second washing solution (i.e., in step (h), as discussed herein), in the third washing solution (i.e., step (k), as discussed herein), and when used to add to a precursor co-solvent based miscella is the same as the polar solvent present in the initial co-solvent based miscella. In other embodiments of the second embodiment, the polar solvent present in the first washing solution (i.e., in step (e), as discussed herein), in the second washing solution (i.e., in step (h), as discussed herein), in the third washing solution (i.e., step (k), as discussed herein), when used to add to a precursor co-solvent based miscella is different than the polar solvent present in the initial co-solvent based miscella; in certain such embodiments, as discussed elsewhere herein, each washing solution comprises the same polar solvent.

According to the process of the second embodiment, the particular polar solvent present in the initial co-solvent based miscella, in the first washing solution, in the second washing solution, in the third washing solution may vary, and when used to add to a precursor co-solvent based miscella. In certain embodiments of the second embodiment, the polar solvent in the initial co-solvent based miscella, in the first washing solution, in the second washing solution, in the third washing solution, and when used to add to a precursor co-solvent based miscella is selected from the group consisting of alcohols having 1 to 8 carbon atoms (e.g., ethanol, isopropanol, ethanol and the like); ethers and esters having from 2 to 8 carbon atoms; cyclic ethers having from 4 to 8 carbon atoms; and ketones having from 3 to 8 carbon atoms (e.g., acetone, methyl ethyl ketone and the like); and combinations thereof. In preferred embodiments of the second embodiment, the polar solvent in the initial co-solvent based miscella, in the first washing solution, in the second washing solution, in the third washing solution, and when used to add to a precursor co-solvent based miscella is selected from ketones having from 3 to 8 carbon atoms (e.g., acetone, methyl ethyl ketone and the like). In particularly preferred embodiments, the polar solvent in the first washing solution, in the second washing solution, in the third washing solution, and when used to add to a precursor co-solvent based miscella comprises acetone (i.e., includes acetone) or consists of acetone (i.e., acetone is the only such polar solvent).

### Non-Polar Solvent

As mentioned above, according to the process of the second embodiment, at least one non-polar solvent is present in various stages of the process. More specifically, as discussed above, the initial co-solvent miscella comprises at least one non-polar solvent (in addition to at least one polar solvent, solubilized guayule rubber, and solubilized resin), the first washing solution comprises non-polar solvent (and polar solvent), the second washing solution comprises non-polar solvent (and polar solvent), and the third washing solution comprises non-polar solvent (and polar solvent). In certain preferred embodiments of the second embodiment, the non-polar solvent present in the first washing solution (i.e., in step (e), as discussed herein), in the second washing solution (i.e., in step (h), as discussed herein), and in the third washing solution (i.e., step (k), as discussed herein), is the same as the non-polar solvent present in the initial co-solvent based miscella. In other embodiments of the second embodiment, the non-polar solvent present in the first washing solution (i.e., in step (e), as discussed herein), in the second washing solution (i.e., in step (h), as discussed herein), and in the third washing solution (i.e., step (k), as discussed herein), is different than the non-polar solvent present in the initial co-solvent based miscella; in certain such embodiments, as discussed elsewhere herein, each washing solution comprises the same non-polar solvent.

According to the process of the second embodiment, the particular non-polar solvent present in the initial co-solvent based miscella, in the first washing solution, in the second washing solution, and in the third washing solution may vary. In certain embodiments of the second embodiment, the non-polar solvent in the initial co-solvent based miscella, in the first washing solution, in the second washing solution, and in the third washing solution is selected from the group consisting of alkanes having from 4 to 9 carbon atoms (e.g., pentane, hexane, heptanes, nonane and the like); cycloalkanes and alkyl cycloalkanes having from 5 to 10 carbon atoms (e.g., cyclohexane, cyclopentane and the like); aromatics and alkyl substituted aromatics having from 6 to 12 carbon atoms (e.g., benzene, toluene, xylene and the like); and combinations thereof. In preferred certain embodiments of the second embodiment, the non-polar solvent in the initial co-solvent based miscella, in the first washing solution, in the second washing solution, and in the third washing solution is selected from the group consisting of alkanes having from 4 to 9 carbon atoms (e.g., pentane, hexane, heptanes, nonane and the like), more preferably from alkanes having 5 or 6 carbon atoms. In particularly preferred embodiments of the second embodiment, the non-polar solvent in the initial co-solvent based miscella, in the first washing solution, in the second washing solution, and in the third washing solution is selected from C6 alkanes or cycloalkanes (e.g., hexane, isohexane, cyclohexane); in certain such embodiments, the only non-polar solvent used is selected from C6 alkanes or cycloalkanes. In certain embodiments of the second embodiment when the non-polar solvent is selected from C6 alkanes or cycloalkanes, isohexane, cyclohexane, or a combination thereof may be preferred for environmental reasons. In other particularly preferred embodiments of the second embodiment, the non-polar solvent in the initial co-solvent based miscella, in the first washing solution, in the second washing solution, and in the third washing solution is selected from C5 alkanes or cycloalkanes (e.g., pentane, cyclohexane), or a combination thereof; in certain such embodiments, the only non-polar solvent used in selected from C5 alkanes or cycloalkanes.

It should be understood that the process of the second embodiment can be considered an entirely separate embodiment, or alternatively can be understood as a process for preparing the purified guayule rubber of the first embodiment (which is discussed in detail above). Therefore, the variations with respect to the properties of the purified guayule natural rubber that are obtained according to the process of the second embodiment should be understood as including the Mw, Mn, Mw/Mn, resin content and ash content values and ranges discussed in detail above for the first embodiment as if those values and ranges were discussed explicitly with respect to the process of the second embodiment.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

What is claimed is:

1-21. (canceled)

22. A purified guayule natural rubber having
a Mw of at least 1.2 million grams/mole, preferably 1.25 to 1.35 grams/mole,
an Mn of at least 0.25 million grams/mole, preferably 0.3 to 0.4 million grams/mole,
a Mw/Mn of 3-4, preferably 3.3 to 3.8,
a resin content of about 0.5 to about 5% by weight, and
an ash content of about 0.1 to about 0.2 weight %.

23. The purified guayule natural rubber of claim 22, wherein the Mw is about 1.3 million grams/mole and the Mn is about 0.35 grams/mole.

24. The purified guayule natural rubber of claim 22, wherein the Mw is about 1.25 million grams/mole and the Mn is about 0.33 grams/mole.

25. The purified guayule natural rubber according to claim 22, wherein the Mw/Mn is about 3.5.

26. The purified guayule natural rubber according to claim 22, having a Mooney viscosity (ML1+4 at 100° C.) of at least 65, preferably at least 70.

27. The purified guayule natural rubber according to claim 22, wherein the resin content is about 1 to about 5% by weight, preferably about 2 to about 5% by weight.

28. A process for preparing the purified guayule natural rubber according to claim 22, the process comprising:
(a) providing an initial co-solvent based miscella comprising at least one polar solvent in an amount about 55 to about 70% by weight based upon the total weight of solvents in the initial co-solvent based miscella, at least one non-polar solvent, solubilized guayule rubber, and solubilized resin;
(b) using a fractionation system comprising multiple fractionators connected in series to separate the initial co-solvent based miscella into at least two phases, wherein the multiple fractionators include a first fractionator, at least two intermediate fractionators including a first intermediate fractionator and a second intermediate fractionator, and a final fractionator, and wherein each fractionator comprises a primary vessel;
wherein the initial co-solvent based miscella is fed into the first fractionator primary vessel, and the initial co-solvent based miscella separates to form (i) a first non-polar solvent viscous rubber phase in a lower portion of the first fractionator primary vessel and (ii) a first polar solvent solubilized resin phase above the first non-polar solvent viscous rubber phase;
(c) allowing the first polar solvent solubilized resin phase to flow out of the first fractionator;
(d) allowing the first non-polar solvent viscous rubber phase to flow out of the first fractionator primary vessel;
(e) adding a combination of a first washing solution comprising a combination of polar solvent and non-polar solvent and the first non-polar solvent viscous rubber phase to the first intermediate fractionator primary vessel to form a first co-solvent based miscella mixture and allowing for separation of the first co-solvent based miscella mixture into (i) a first intermediate non-polar solvent viscous rubber phase in a lower portion of the first intermediate fractionator primary vessel and (ii) a first intermediate polar solvent solubilized resin phase above the first intermediate non-polar solvent viscous rubber phase, wherein the first washing solution comprises about 40 to about 80% by weight of polar solvent based upon the total weight of solvents in the first washing solution, and the first washing solution is added in an amount sufficient to provide a weight ratio of first washing solution to non-polar solvent viscous rubber phase from the first fractionator primary vessel of 0.5:1 to 5:1;
(f) allowing the first intermediate polar solvent solubilized resin phase to flow out of the first intermediate fractionator primary vessel;
(g) allowing the first intermediate non-polar solvent viscous rubber phase to flow out of the first intermediate fractionator primary vessel;
(h) adding a combination of a second washing solution comprising polar solvent and non-polar solvent and the first intermediate non-polar solvent viscous rubber phase to the second intermediate fractionator primary vessel to form a second co-solvent based miscella mixture and allowing for separation of the second co-solvent based miscella mixture into (i) a second intermediate non-polar solvent viscous rubber phase in a lower portion of the second intermediate fractionator primary vessel and (ii) a second intermediate polar solvent solubilized resin phase above the second intermediate non-polar solvent viscous rubber phase, wherein the second washing solution comprises about 40 to about 80% by weight of polar solvent based upon the total weight of solvents in the second washing solution, and the second washing solution is added in an amount sufficient to provide a weight ratio of second washing solution to non-polar solvent viscous rubber phase from the second fractionator primary vessel of 0.5:1 to 5:1;
(i) allowing the second intermediate polar solvent solubilized resin phase to flow out of the second intermediate fractionator primary vessel;
(j) allowing the second intermediate non-polar solvent viscous rubber phase to flow out of the second intermediate fractionator primary vessel;
(k) adding a combination of a third washing solution comprising polar solvent and non-polar solvent and the second intermediate non-polar solvent viscous rubber phase to the final fractionator primary vessel to form a final co-solvent based miscella mixture and allowing for separation of the final co-solvent based miscella mixture into (i) a final non-polar solvent viscous rubber phase in a lower portion of the final fractionator primary vessel and (ii) a final polar solvent solubilized resin phase above the final non-polar solvent viscous rubber phase, wherein the third washing solution comprises about 40 to about 80% by weight of polar solvent based upon the total weight of solvents in the third washing solution, and the third washing solution is added in an amount sufficient to provide a weight ratio of third washing solution to non-polar solvent viscous rubber phase from the third fractionator primary vessel of 0.5:1 to 5:1;
(l) allowing the final polar solvent solubilized resin phase to flow out of the final fractionator primary vessel;
(m) allowing the final non-polar solvent viscous rubber phase to flow out of the final fractionator primary vessel, thereby providing a separated solubilized rubber phase with reduced resin and polar solvent content as compared to the initial co-solvent based miscella and wherein the separated solubilized rubber phase contains about 75 to about 85% by weight solvents based upon the total weight of the separated solubilized rubber phase; and
(n) removing solvent from the separated solubilized rubber phase to produce a purified guayule rubber having a solvent content of no more than 0.5% by weight.

29. The process of claim 28, wherein the polar and non-polar solvents in the first washing solution, the second washing solution and the third washing solution are identical.

30. The process of claim 28, wherein the amount of polar solvent in each of the first washing solution, the second washing solution and the third washing solution is identical.

31. The process of claim 28, wherein the amount of polar solvent in each of the first washing solution, the second washing solution and the third washing solution is 48 to 65% by weight based upon the total weight of solvents in each washing solution.

32. The process of claim 28, wherein the amount of polar solvent in each of the first washing solution, the second washing solution and the third washing solution is 50 to 60% by weight based upon the total weight of solvents in each washing solution, preferably 55 to 60% by weight based upon the total weight of solvents in each washing solution.

33. The process of claim 28, wherein the first washing solution is provided by the polar solvent solubilized resin phase which flows out of the second intermediate fractionator primary vessel.

34. The process of claim 28, wherein the second washing solution is provided by the polar solvent solubilized resin phase which flows out of the final fractionator primary vessel.

35. The process of claim 28, wherein the amount of washing solutions added in each of (e), (h), and (k) is sufficient to provide a weight ratio of washing solution to non-polar solvent viscous rubber phase of 2:1 to 4:1, preferably 3:1 to 4:1.

36. The process of claim 28, wherein the initial co-solvent based miscella is prepared by adding polar solvent to a precursor co-solvent based miscella in an amount sufficient to increase the polar solvent content to about 55 to about 70% by weight based upon the total weight of solvents in the initial co-solvent based miscella, and wherein the precursor co-solvent based miscella comprises about 1 to about 8%, preferably about 2 to about 6%, more preferably about 2 to about 5% by weight rubber based upon the total weight of the precursor co-solvent based miscella; about 2 to about 12%, preferably about 3 to about 10%, more preferably about 4 to about 8% by weight resin; about 60 to about 90% preferably about 70 to about 85%, more preferably about 70 to about 80% by weight non-polar solvent based upon the total weight of solvents in the precursor co-solvent based miscella; and about 10 to about 40%, preferably about 15 to about 30, more preferably about 20 to about 30% by weight polar solvent based upon the total weight of solvents in the precursor co-solvent based miscella.

37. The process of claim 28, wherein the initial co-solvent miscella is prepared by adding polar solvent to a precursor co-solvent based miscella in an amount sufficient to increase the polar solvent content to about 55 to about 70% by weight based upon the total weight of solvents in the initial co-solvent based miscella, and wherein the precursor co-solvent based miscella comprises about 3 to about 20%, preferably about 5 to about 15%, more preferably about 5 to about 12% by weight rubber based upon the total weight of the precursor co-solvent based miscella; about 5 to about 30%, preferably about 6 to about 25%, more preferably about 8 to about 20% by weight resin based upon the total weight of the precursor co-solvent based miscella; about 60 to about 90%, preferably about 70 to about 85%, more preferably about 70 to about 80% by weight non-polar solvent based upon the total weight of solvents in the precursor co-solvent based miscella; and about 10 to about 40%, preferably about 15 to about 30, more preferably about 20 to about 30% by weight polar solvent based upon the total weight of solvents in the precursor co-solvent based miscella.

38. The process of claim 28, wherein the polar solvent added in (e), (h), and (k) is the same as the polar solvent present in the initial co-solvent based miscella and any precursor co-solvent based miscella, and any non-polar solvent added in (e), (h), and (k) is also the same as the non-polar solvent present in the initial co-solvent based miscella and any precursor co-solvent based miscella.

39. The process of claim 28, wherein the polar solvent in (e), (h), and (k) as well as the polar solvent present in the initial co-solvent based miscella and any precursor co-solvent based miscella is selected from the group consisting of alcohols having 1 to 8 carbon atoms; ethers and esters having from 2 to 8 carbon atoms; cyclic ethers having from 4 to 8 carbon atoms; and ketones having from 3 to 8 carbon atoms; and combinations thereof.

40. The process of claim 28, wherein the polar solvent in (e), (h), and (k) as well as the polar solvent present in the initial co-solvent based miscella and any precursor co-solvent based miscella is acetone.

41. The process of claim 28, wherein the non-polar solvent in (e), (h), and (k) as well as the non-polar solvent present in the initial co-solvent based miscella and any precursor co-solvent based miscella is selected from the group consisting of alkanes having from 4 to 9 carbon atoms; cycloalkanes and alkyl cycloalkanes having from 5 to 10 carbon atoms; aromatics and alkyl substituted aromatics having from 6 to 12 carbon atoms; and combinations thereof, preferably selected from the group consisting of an alkane having 5 carbon atoms, a cycloalkane having 5 carbon atoms, or a combination thereof.

42. The process of claim 28, wherein the non-polar solvent in (e), (h), and (k) as well as the non-polar solvent present in the initial co-solvent based miscella and any precursor co-solvent based miscella is n-hexane, isohexane, cyclohexane, or a combination thereof, preferably a combination of isohexane and cyclohexane.
